(19) United States
(12) Patent Application Publication
(10) Pub. No.: US 2013/0201970 A1
(43) Pub. Date: Aug. 8, 2013

(54) WIRELESS COMMUNICATION SYSTEM, WIRELESS COMMUNICATION CONTROL METHOD, AND WIRELESS COMMUNICATION DEVICE

(71) Applicant: FUJITSU LIMITED, Kawasaki-shi (JP)

(72) Inventors: Hiroshi FUJITA, Yokosuka (JP); Yun Wen, Kawasaki (JP); Kazuyuki Ozaki, Yokohama (JP)

(21) Appl. No.: 13/665,150

(22) Filed: Oct. 31, 2012

(30) Foreign Application Priority Data
Feb. 7, 2012 (JP) 2012-024527

(51) Int. Cl. H04W 72/04

(52) U.S. Cl. 370/336

(57) ABSTRACT

Each node transmits to a destination node a registration packet indicating that a local node is a node to request packet transmission. Each node transmits a packet to the destination node within a transmission time reported from the destination node. The destination node receives a registration packet from each node, and calculates a traffic amount to occur in each path for every path going through an adjacent node that enables direct communication with the destination node. The destination node assigns a transmission time to transmit the packet to the each path based on the calculated traffic amount of each path and reports the assigned transmission time to each node.

### CROSS-REFERENCE TO RELATED APPLICATION

This application is based upon and claims the benefit of priority of the prior Japanese Patent Application No. 2012-024527, filed on Feb. 7, 2012, the entire contents of which are incorporated herein by reference.

### FIELD

The embodiments discussed herein are related to a wireless communication system, a wireless communication control method and a wireless communication device.

### BACKGROUND

In recent years, a multi-hop wireless communication system connecting to a destination node via a plurality of relay nodes attracts attention. In the multi-hop wireless communication system, each node autonomously performs communication using a CSMA/CA (Carrier Sense Multiple Access with Collision Avoidance) scheme.

In the CSMA/CA, each node performs carrier sense before performing communication, and monitors RSSI (Received Signal Strength Indication). Subsequently, in the case of detecting the RSSI equal to or less than a certain value or not detecting the RSSI, each node decides that other nodes do not perform transmission, and performs data transmission.

However, in this method, there occurs data collision with a node that is within a range, in which direct communication with a destination node is possible, and that is difficult to detect carrier sense of transmission of a transmission node. That is, packet collision occurs between a transmission node and a node in which a reception power from the transmission node is equal to or less than a threshold (hereinafter referred to as “hidden terminal”), and, for example, there occurs a phenomenon that a packet does not arrive at the destination.

As a technique of efficiently transmitting packets in such a wireless communication system, for example, there is known a technique that each node requests a communication time area in a slot for time assignment and uniquely determines the assignment time based on the number of hops. Also, there is known a technique that a node which can communicate with a destination node by one hop transmits packets using a time division multiplexing scheme and other nodes transmit packets using the CSMA/CA scheme in a different area from a time division slot.
Patent Literature 1: Japanese Laid-open Patent Publication No. 2008-228178
Patent Literature 2: Japanese Laid-open Patent Publication No. 2011-188095

However, in the related art, there is a high possibility of packet collision between nodes that transmit packets by the same hop number from a destination node, and the cost for generating a node becomes higher, and therefore there is a problem that it is difficult to suppress the packet collision.

For example, in a technique of uniquely determining an assignment time based on the number of hops, all nodes that transmit packets to a destination node by the same hop number from the destination node start packet transmission at the same timing. Therefore, there is a high possibility of packet collision between nodes of a hidden terminal relationship in the same hop. Also, in a technique using the time division multiplexing scheme, both the time division multiplexing scheme and the CSMA/CA scheme are mounted in one node, and therefore the cost becomes higher.

### SUMMARY

According to an aspect of the embodiments, a wireless communication system in which a plurality of nodes form a multi-hop wireless network, wherein each node includes: a first transmission unit that transmits to a destination node a registration packet indicating that a local node is a node to request packet transmission; and a second transmission unit that transmits a packet to the destination node within a transmission time reported from the destination node, and the destination node includes: a calculation unit that receives a registration packet from the each node, and calculates a traffic amount to occur in each path for every path going through an adjacent node that enables direct communication with the destination node; an assignment unit that assigns a transmission time to transmit the packet to the each path, based on the traffic amount of the each path calculated by the calculation unit; and a report unit that reports the transmission time assigned by the assignment unit to the each node.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating a whole configuration example of a wireless communication system according to a first embodiment;

FIG. 2 is a view illustrating a hardware configuration example of a gateway and node according to the first embodiment;

FIG. 3 is a function block diagram illustrating a configuration of a node according to the first embodiment;

FIG. 4 is a view illustrating a format example of a registration packet;

FIG. 5 is a function block diagram illustrating a configuration of a gateway according to the first embodiment;

FIG. 6 is a view illustrating a format example of an assignment report packet;

FIG. 7 is a flowchart illustrating a flow of processing performed by GW according to the first embodiment;

FIG. 8 is a view of a processing sequence performed by a wireless communication system according to the first embodiment;

FIG. 9 is a view of a processing sequence performed by the wireless communication system according to the first embodiment;

FIG. 10 is a view illustrating a specific node arrangement example;

FIG. 11 is a view illustrating a specific transmission time assignment example;

FIG. 12 is a view for explaining an average collision rate in the case of using the related art;

FIG. 13 is a view for explaining an average collision rate in the case of using the first embodiment; and

FIG. 14 is a view illustrating calculation results.

### DESCRIPTION OF EMBODIMENTS

Preferred embodiments will be explained with reference to accompanying drawings.

Also, the present invention is not limited to these embodiments.

### [a] First Embodiment

Whole Configuration Example

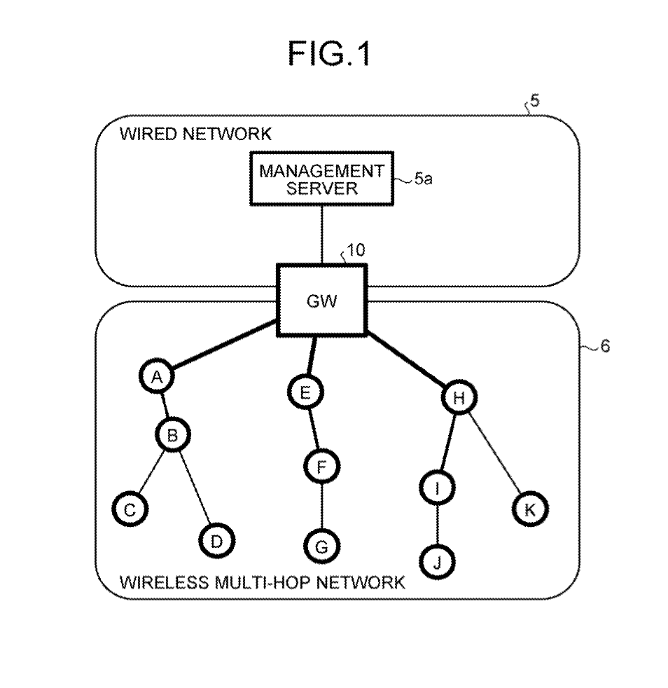

FIG. 1 is a view illustrating a whole configuration example of a wireless communication system according to a first embodiment. As illustrated in FIG. 1, in this wireless communication system, a wired network 5 and a wireless multi-hop network 6 are connected via a gateway device (GW) 10. Also, the reference numerals of devices illustrated in FIG. 1 are just examples and are not limited to these.

The wired network 5 is an IP (Internetwork Protocol) network to perform data communication by IP or the like, and includes a management server 5a connected to the GW 10. The management server 5a is a server device to collect data detected in the wireless multi-hop network 6 and perform the power supply management and abnormity detection of each node in the wireless multi-hop network 6.

The GW 10 is a device to collect data from each node in the wireless multi-hop network 6 and transmits it to the management server 5a, and has a function to perform wireless communication and a function to perform communication using a LAN (Local Area Network) or the like.

The wireless multi-hop network 6 is a wireless network configured with a plurality of nodes forming an ad-hoc network. In the case of FIG. 1, the wireless multi-hop network 6 is configured with nodes A, B, C, D, E, F, G, H, I, J and K.

Each node illustrated in FIG. 1 is a wireless communication terminal to transmit packets using the CSMA/CA scheme. Also, each node has various sensors such as an electricity meter, acceleration sensor and temperature sensor, inside or outside the node. Also, each node transmits, to the GW 10, data packets including a sensor value which is a value sensed by various sensors.

Here, the node A is an adjacent node that can directly communicate with the GW 10, the node B is a node to transmit data to the GW 10 via the node A, and the nodes C and D are nodes to transmit data to the GW 10 via the nodes B and A in order. Also, the node E is an adjacent node that can directly communicate with the GW 10, the node F is a node to transmit data to the GW 10 via the node E, and the node G is a node to transmit data to the GW 10 via the nodes F and E in order. Also, the node H is an adjacent node that can directly communicate with the GW 10, the nodes I and K are nodes to transmit data to the GW 10 via the node H, and the node J is a node to transmit data to the GW 10 via the node I and H in order.

Also, an adjacent node such as the node A located in a position in which the GW 10 can detect radio waves is referred to as “1-hop node,” and other nodes than the 1-hop node are referred to as “multi-hop node.”

Also, each node exchanges control messages such as HELLO packets including path information held by the node with an adjacent node, and thereby autonomously updates the path information and forms a path to a destination node. Here, the path information can be dynamically and automatically generated by each node or manually updated by, for example, a manager.

In such a wireless multi-hop network, each node transmits, to the GW 10, a registration packet indicating a node which a local node requests to transmit a packet. Also, each node transmits a packet to the GW 10 within a transmission time reported from the GW 10. The GW 10 receives the registration packet from each node and calculates the traffic amount caused in each path, every path going through an adjacent node that can directly communicate with the GW 10. Also, the GW 10 assigns, to each path, a transmission time to transmit a packet, based on the traffic amount calculated for each path. Also, the GW 10 reports the assigned transmission time to each node.

Thus, the GW 10 according to the first embodiment can assign a transmission time every path including an adjacent node. Also, each node can perform packet transmission within a range of the transmission time assigned from the GW 10. That is, since different resources are assigned to nodes of a large traffic amount, a packet collision probability decreases even in a hidden terminal relationship and it is possible to improve the capacity. As a result, it is possible to suppress packet collision.

Hardware Configuration

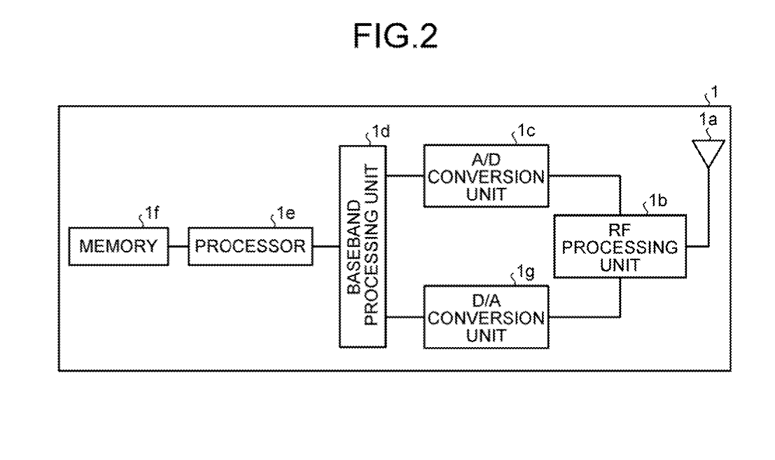

FIG. 2 is a view illustrating a hardware configuration example of a gateway and node according to the first embodiment. Also, the gateway and the node have a similar configuration, and it will be explained as a terminal 1 below.

The terminal 1 includes an antenna 1a, an RF processing unit 1b, an A/D conversion unit 1c, a baseband processing unit 1d, a processor 1e, a memory 1f and a D/A conversion unit 1g. The antenna 1a is hardware to transmit a signal corresponding to data to a destination as a radio wave and receive a signal corresponding to data as a radio wave. Also, the exemplified hardware is just an example and is not limited to this, and hardware such as a modulation unit may be included. Also, the GW 10 includes, for example, an interface connected to a wired network, in addition to the hardware illustrated in FIG. 2.

The RF processing unit 1b is, for example, a circuit to convert the RF signal received by the antenna 1a into an IF signal or the like, amplify it and subsequently output the result to the A/D conversion unit 1c. Also, the RF processing unit 1b is, for example, a circuit to convert a digital signal input from the D/A conversion unit 1g into an RF signal or the like, amplify it and subsequently cause the result to be output from the antenna 1a.

The A/D conversion unit 1c is, for example, a circuit to convert an analog signal such the IF signal input from the RF processing unit 1b into a digital signal and output it to the baseband processing unit 1d. The baseband processing unit 1d is a circuit to perform demodulation processing or error correction processing on the digital signal input from the A/D conversion unit 1c. Also, the baseband processing unit 1d performs, for example, modulation processing on data input from the processor 1e and outputs the result to the D/A conversion unit 1g.

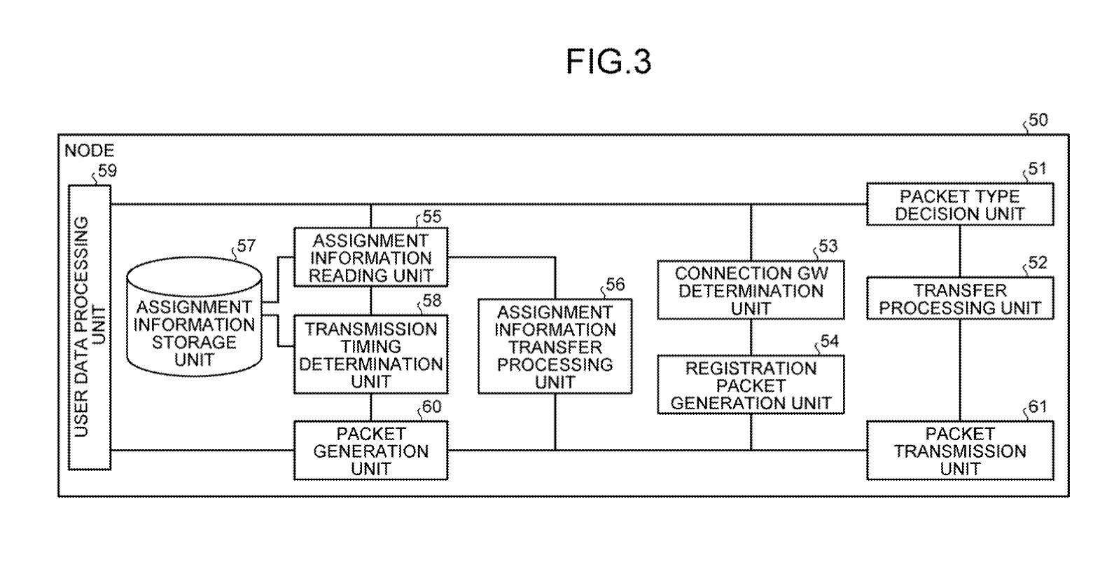

The processor 1e is a processor such as a CPU (Central Processing Unit) and DSP (Digital Signal Processor), and manages the overall control of the terminal 1. This processor 1e performs processing performed by, for example, each function unit illustrated in FIG. 3 or FIG. 5, on the digital signal output from the baseband processing unit 1d. Also, the processor 1e generates data of the transmission target and outputs it to the baseband processing unit 1d.

The memory 1f is a storage device to store, for example, a program executed by the processor 1e, data used by the processor 1e and various kinds of information. For example, the memory 1f stores information stored in an assignment information storage unit 57 illustrated in FIG. 3 or information stored in a path-specific traffic amount storage unit 12 illustrated in FIG. 5. The D/A conversion unit 1g is a circuit to convert the digital signal output from the baseband processing unit 1d into an analog signal and output it to the RF processing unit 1b.

Node Configuration

FIG. 3 is function block diagram illustrating a configuration of a node according to the first embodiment. Each node illustrated in FIG. 1 has a similar configuration, and therefore it will be explained as a node 50. Also, each processing unit illustrated herein is just an example and is not limited to this.

As illustrated in FIG. 3, the node 50 includes a packet type decision unit 51, a transfer processing unit 52, a connection GW determination unit 53 and a registration packet generation unit 54. Also, the node 50 includes an assignment information reading unit 55, an assignment information transfer processing unit 56, an assignment information storage unit 57, a transmission timing determination unit 58, a user data processing unit 59, a packet generation unit 60 and a packet transmission unit 61.

The packet type decision unit 51 is a processing unit to decide the types of received packets and output the received packets to processing units corresponding to the types. For example, the packet type decision unit 51 extracts information indicating a packet type included in the header of a received packet. Subsequently, in the case of an identifier indicating that the packet type is “assignment report,” the packet type decision unit 51 outputs the received packet to the assignment information reading unit 55. Also, in the case of an identifier indicating that the packet type is a control message such as “HELLO,” the packet type decision unit 51 outputs the received packet to the connection GW determination unit 53. Also, in the case of an identifier indicating a transfer target packet in which the packet type is unicast and the destination is not the local node, the packet type decision unit 51 outputs the received packet to the transfer processing unit 52.

That is, a transfer target packet is output from the packet type decision unit 51 to the transfer processing unit 52. Also, a path information packet is output from the packet type decision unit 51 to the connection GW determination unit 53. An assignment report packet is output from the packet type decision unit 51 to the assignment information reading unit 55. A data packet directed to the local node is output from the packet type decision unit 51 to the user data processing unit 59.

The transfer processing unit 52 performs processing of transferring the transfer target packet input from the packet type decision unit 51 to an adjacent node directed for the destination. For example, in a case where a data packet transmitted from a controlled node is received, the transfer processing unit 52 transfers the data packet to a path node directed for the GW 10. This transfer processing unit 52 transfers unicast packets such as a sensor data packet and a registration packet. Also, since the assignment report packet is a broadcast packet, it is received once and transmitted anew. Therefore, the assignment report packet does not go through the transfer processing unit 52.

When an example of a transfer method is explained, the transfer processing unit 52 rewrites an “adjacent destination” included in, for example, the header of an input packet into address information of a transfer destination node adjacent to the local node, rewrites the “adjacent transmission source” into address information of the local node and outputs it to the packet transmission unit 61. That is, the transfer processing unit 52 does not rewrite global information indicating the final destination or the packet generation source, and rewrites local information indicating the transfer destination or the transfer source and transfers the result to the next node. Also, path information to specify a transfer destination node is generated by, for example, the connection GW determination unit 53 (described later) and stored in, for example, a memory.

The connection GW determination unit 53 is a processing unit to determine a GW of connection destination based on path information exchanged with an adjacent node. Also, the connection GW determination unit 53 is a processing unit to determine the first transfer destination node for transmission to the connection destination GW. That is, the connection GW determination unit 53 determines a representative terminal ID to identify a representative terminal (described later). In a case where assignment information is received, this representative terminal ID is information identifying a group to which the subject device belongs.

For example, the connection GW determination unit 53 extracts path information from each HELLO packet input from the packet type decision unit 51 and stores it in a memory or the like. Subsequently, the connection GW determination unit 53 determines the GW 10 of connection destination from the extracted path information and reports to the registration packet generation unit 54 that the GW 10 is determined. Also, the connection GW determination unit 53 generates a routing table from the extracted path information and stores it in the memory or the like.

Also, using the number of hops or path quality, the connection GW determination unit 53 can determine the connection destination GW and generate the routing table. As an example, in the case of receiving from an adjacent node a packet to report that the GW 10 is a connection destination, the connection GW determination unit 53 determines a connection destination GW. Also, the connection GW determination unit 53 can generate topology information using path information or the like and determine a route node of the topology information as a connection destination GW. Also, regarding a path to the connection destination GW, the connection GW determination unit 53 can determine a path order with a smaller number of hops or determine it in order of path quality reported by HELLO packets or the like.

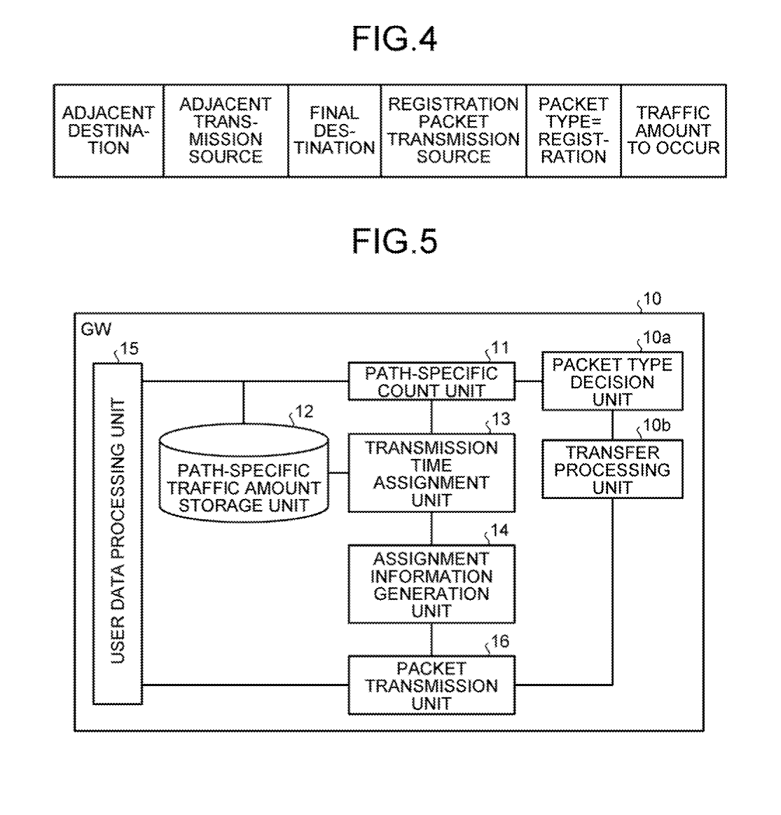

The registration packet generation unit 54 is a processing unit to generate a registration packet including the traffic amount to be transmitted by the node 50. For example, when a connection destination GW is determined by the connection GW determination unit 53, the registration packet generation unit 54 generates a registration packet and outputs it to the packet transmission unit 61. Here, the generated registration packet will be explained. FIG. 4 is a view illustrating a format example of the registration packet. As illustrated in FIG. 4, the registration packet includes an “adjacent destination, adjacent transmission source, final destination, registration packet transmission source, packet type and traffic amount to occur.”

The “adjacent destination” is address information indicating a transfer destination node, and, for example, in a case where an adjacent node to the node 50 is the node A, stores address information of the node A. The “adjacent transmission source” is address information indicating a transfer source node, and, for example, in a case where the node 50 transfers a registration packet received from the node C to the node A, stores address information of the node 50. These “adjacent destination” and “adjacent transmission source” are rewritten at the transfer timing. The “final destination” is information indicating the destination of the registration packet and stores address information of the GW 10. The “registration packet transmission source” stores address information of a node that generates the registration packet. The “packet type” stores an identifier to specify the packet type and stores “registration” in the case of a registration packet. The “traffic amount to occur” indicates the amount of data to be transmitted by the node 50 and stores, for example, the number of bits. Also, the traffic amount to occur is held in a memory or the like by, for example, a manager.

The assignment information reading unit 55 is a processing unit to read a time period in which the local node can transmit data, from the assignment report packet output from the packet type decision unit 51. For example, the assignment information reading unit 55 reads information such as a period between 60 seconds after the start of transmission and 120 seconds, from the assignment report packet, and stores it in the assignment information storage unit 57 as a time period in which transmission is possible.

The assignment information transfer processing unit 56 is a processing unit to perform processing of transferring received assignment information to a controlled node. For example, the assignment information transfer processing unit 56 generates an assignment report packet using the assignment information read by the assignment information reading unit 55. At this time, the assignment information transfer processing unit 56 broadcasts an adjacent destination and final destination and changes the representative terminal ID of each area to the ID of the subject device.

The assignment information storage unit 57 is a storage unit to store the time period stored by the assignment information reading unit 55. Also, the assignment information storage unit 57 stores a transmission start time that is commonly held by each node of the wireless multi-hop network. As an example, the assignment information storage unit 57 stores, for example, 10:00, 11:00 or 12:00 as a transmission start time of packets including sensor data.

The transmission timing determination unit 58 is a processing unit to detect a packet transmission start time of the local node. For example, when information is stored in the assignment information storage unit 57, the transmission timing determination unit 58 reads a stored transmission start time and a time period in which transmission is possible. Subsequently, the transmission timing determination unit 58 determines a random time in an assigned transmission time as a transmission timing, monitors time information measured by the node 50, and, when the time in which transmission is possible is reached in the local node, instructs the packet generation unit 60 to generate a packet. After that, when the time period in which transmission is possible passes over, the transmission timing determination unit 58 causes the packet generation unit 60 to finish the packet generation.

When it is explained using the above example, in the case of detecting that it is 10:00, the transmission timing determination unit 58 waits until 60 seconds as a time assigned to the local node elapse, that is, until 10:01. Subsequently, when detecting 10:01, the transmission timing determination unit 58 instructs the packet generation unit 60 to generate a packet. After that, when detecting 10:02, the transmission timing determination unit 58 causes the packet generation unit 60 to finish the packet generation.

The user data processing unit 59 is a processing unit to acquire a sensor value from, for example, a sensor held in the node 50 or a sensor connected to the outside of the node 50. For example, the user data processing unit 59 executes various applications, acquires a value sensed by a sensor and outputs it to the packet generation unit 60.

The packet generation unit 60 is a processing unit to generate a data packet including a sensor value. For example, the packet generation unit 60 receives the sensor value from the user data processing unit 59. Subsequently, in a case where the transmission timing determination unit 58 gives an instruction to generate a packet, the packet generation unit 60 generates a data packet including the sensor value and outputs the result to the packet transmission unit 61. After that, in a case where the transmission timing determination unit 58 gives an instruction to finish the packet generation, the packet generation unit 60 finishes the data packet generation.

The packet transmission unit 61 is a processing unit to transmit various packets to a destination. For example, the packet transmission unit 61 transmits the transfer target packet input from the transfer processing unit 52, the registration packet input from the registration packet generation unit 54, the data packet input from the packet generation unit 60 and the assignment report packet input from the assignment information transfer processing unit 56, to the destination. Also, when transmitting each packet, the packet transmission unit 61 performs carrier sense, checks that a channel is available, and then performs transmission.

GW Configuration

FIG. 5 is a function block diagram illustrating a configuration of a gateway according to the first embodiment. Each processing unit illustrated herein is just an example and is not limited to this.

As illustrated in FIG. 5, the GW 10 includes a packet type decision unit 10a, a transfer processing unit 10b, a path-specific count unit 11, a path-specific traffic amount storage unit 12, a transmission time assignment unit 13, an assignment information generation unit 14, a user data processing unit 15 and a packet transmission unit 16.

The packet type decision unit 10a is a processing unit to decide the types of received packets and output the received packets to processing units corresponding to the types. For example, the packet type decision unit 10a extracts information indicating a packet type included in the header of a received packet. Subsequently, in the case of an identifier indicating that the packet type is “registration packet,” the packet type decision unit 10a outputs the received packet to the path-specific count unit 11. Also, in the case of an identifier indicating that the packet type is “data packet,” the packet type decision unit 51 outputs the received packet to the transfer processing unit 10b.

The transfer processing unit 10b is a processing unit to transfer the data packet output from the packet type decision unit 10a, to the management server 5a or the like. For example, in a case where the data packet such as sensor data transmitted from each node is received, the transfer processing unit 10b transfers the received packet to the management server 5a. Also, the transfer processing unit 10b transfers the packet transmitted from the management server 5a to each node.

The path-specific count unit 11 is a processing unit to calculate the traffic amount for each path and store it in the path-specific traffic amount storage unit 12. To be more specific, the path-specific count unit 11 calculates the traffic amount every 1-hop node. That is, the path-specific count unit 11 calculates the traffic amount of each group in the wireless multi-hop network, using nodes going through a 1-hop node as one group.

In the case of FIG. 1, as a path going through the node A, the path-specific count unit 11 calculates the traffic amount using the nodes A, B, C and D as one group. Similarly, as a path going through the node E, the path-specific count unit 11 calculates the traffic amount using the nodes E, F and G as one group. Similarly, as a path going through the node H, the path-specific count unit 11 calculates the traffic amount using the nodes H, I, J and K as one group.

Next, a calculation example of the traffic amount will be explained. The path-specific count unit 11 calculates, as a traffic amount, the sum of bit numbers stored in the “traffic amount to occur” of the registration packet received from each of the nodes A, B, C and D. As another example, the path-specific count unit 11 may calculate the number of registration packets received via the node A, as a traffic amount. Regarding a group going through the node A in FIG. 1, the traffic amount is calculated as 4. Also, by the “adjacent transmission source” of a received registration packet, the path-specific count unit 11 can specify which 1-hop node the registration packet goes through.

Returning to FIG. 5, the path-specific traffic amount storage unit 12 is a storage unit to store the path-specific traffic amount stored by the path-specific count unit 11. For example, the path-specific traffic amount storage unit 12 stores that the traffic amount of the path including the node A is a 350-bit number, the traffic amount of the path including the node E is a 200-bit number and the traffic amount of the path including the node H is a 450-bit number. As another example, in the case of using the node number, the path-specific traffic amount storage unit 12 stores that the traffic amount of the path including the node A is 4, the traffic amount of the path including the node E is 3 and the traffic amount of the path including the node H is 4.

The transmission time assignment unit 13 is a processing unit to assign a transmission time for packet transmission to each path based on the traffic amount of each path calculated by the path-specific count unit 11. To be more specific, the transmission time assignment unit 13 refers to information stored in the path-specific traffic amount storage unit 12 and assigns a transmission time such that a path of a more traffic amount has more transmission time, within a range of a time period in which it is possible to transmit data to the GW 10.

As an example, it is assumed that the time period in which the GW 10 can receive data is 5 minutes, the traffic amount of the path including the node A is a 350-bit number, the traffic amount of the path including the node E is a 200-bit number and the traffic amount of the path including the node H is a 450-bit number. In this case, the transmission time assignment unit 13 calculates a ratio of the traffic amount of the group of the node A to the overall traffic amount as “350/(350+200+450)=0.35.” Similarly, the transmission time assignment unit 13 calculates a ratio of the traffic amount of the group of the node E to the overall traffic amount as “200/(350+200+450)=0.2.” Similarly, the transmission time assignment unit 13 calculates a ratio of the traffic amount of the group of the node H to the overall traffic amount as “450/(350+200+450)=0.45.”

Subsequently, in 5 minutes (300 seconds) in which the GW 10 can receive data, the transmission time assignment unit 13 calculates a time period in which the group of the node A can perform transmission, as “300 seconds×0.35=105 seconds.” Similarly, in 5 minutes (300 seconds) in which the GW 10 can receive data, the transmission time assignment unit 13 calculates a time period in which the group of the node E can perform transmission, as “300 seconds×0.2=60 seconds.” Similarly, in 5 minutes (300 seconds) in which the GW 10 can receive data, the transmission time assignment unit 13 calculates a time period in which the group of the node H can perform transmission, as “300 seconds×0.45=135 seconds.”

As a result, the transmission time assignment unit 13 assigns a time period from the start of transmission to 105 seconds, to the group of the node A. Also, the transmission time assignment unit 13 assigns a time period from 105 seconds after the transmission start to 165 seconds, to the group of the node E. Also, the transmission time assignment unit 13 assigns a time period from 165 seconds after the transmission start to 300 seconds, to the group of the node H. Subsequently, the transmission time assignment unit 13 reports the time period assigned to each path, to the assignment information generation unit 14.

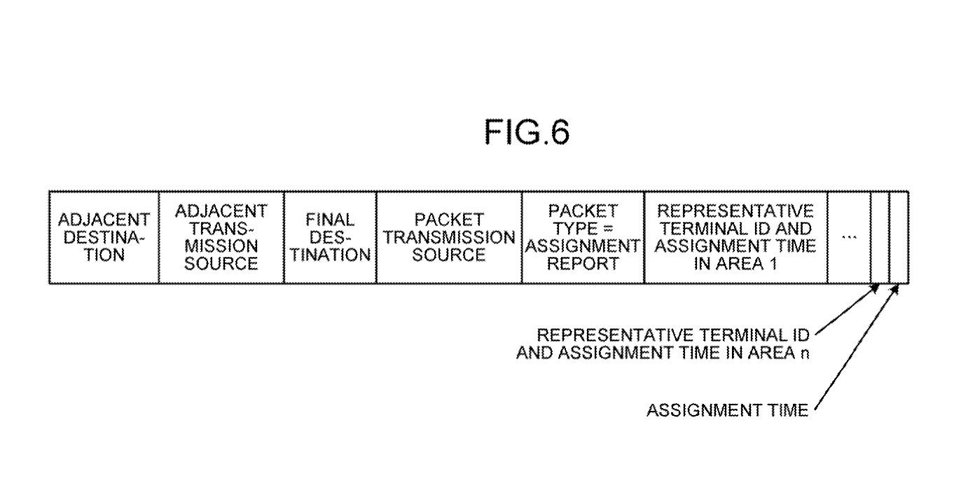

The assignment information generation unit 14 is a processing unit to generate an assignment report packet to report the transmission time assigned by the transmission time assignment unit 13 to each node. To be more specific, the assignment information generation unit 14 generates packets including the path-specific transmission time reported from the transmission time assignment unit 13, and outputs them to the packet transmission unit 16. Here, the assignment report packet will be explained. FIG. 6 is a view illustrating a format example of the assignment report packet. As illustrated in FIG. 6, the assignment report packet includes an “adjacent destination, adjacent transmission source, final destination, packet transmission source, packet type, and representative terminal ID/assignment time of each area.”

The “adjacent destination” is address information indicating a transfer destination node, and, for example, in the case of transmission from the GW 10, stores a broadcast address. The “adjacent transmission source” is address information indicating a transfer source node. These “adjacent destination” and “adjacent transmission source” are rewritten at the transfer timing. The “final destination” is information indicating the destination of the assignment report packet and stores, for example, a broadcast address. The “packet transmission source” stores address information of the GW 10 that generates the assignment report packet. The “packet type” stores an identifier to specify the packet type and stores “assignment report” in the case of an assignment report packet.

The “representative terminal ID of each area” is address information of 1-hop nodes and is prepared by, for example, the number of 1-hop nodes. The “assignment time” stores a transmission time reported from the assignment information generation unit 14. For example, in the case of the above example, the “representative terminal ID of each area” stores “address information of the node A” and the “assignment time” stores a time period “from 0 second after the transmission start to 105 seconds.” Similarly, the “representative terminal ID of each area” stores “address information of the node E” and the “assignment time” stores a time period “from 105 seconds after the transmission start to 165 seconds.” Similarly, the “representative terminal ID of each area” stores “address information of the node H” and the “assignment time” stores a time period “from 165 seconds after the transmission start to 300 seconds.”

Returning to FIG. 5, the user data processing unit 15 is a processing unit to execute various applications and generate various packets. For example, the user data processing unit 15 generates a packet to report that the local node is a connection destination GW and a packet to control the power supply of each node or a sensor connected to each node, and outputs these to the packet transmission unit 16.

The packet transmission unit 16 is a processing unit to transmit the assignment report packet input from the assignment information generation unit 14 and the various packets input from the user data processing unit 15. For example, when transmitting each packet, the packet transmission unit 16 performs carrier sense, checks that a channel is available, and then transmits the above various packets.

Flow of Processing

Next, a flow of processing in a wireless communication system will be explained. Here, the flow of processing performed in the GW 10 and a processing sequence performed in the wireless communication system will be explained.

Flow of Processing Performed by GW

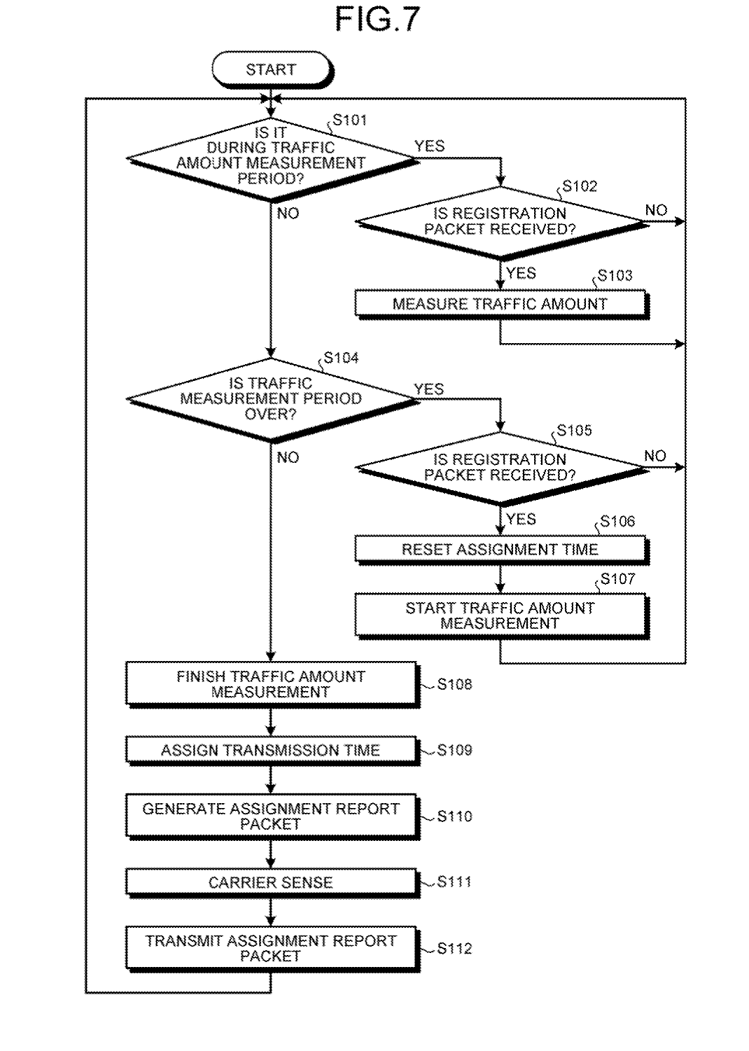

FIG. 7 is a flowchart illustrating a flow of processing performed by the GW according to the first embodiment. As illustrated in FIG. 7, when receiving a registration packet during a traffic amount measurement period (positive in S101 and positive in S102), the path-specific count unit 11 of the GW 10 measures a traffic amount (S103) and returns to S101. Also, every time a registration packet is received, the path-specific count unit 11 of the GW 10 calculates the traffic amount to be stored in the path-specific traffic amount storage unit 12, for each “adjacent transmission source” included in the registration packet.

Meanwhile, when it is not during the traffic amount measurement period (negative in S101), the traffic measurement period is over (positive in S104) and a registration packet is received (positive in S105), the path-specific count unit 11 resets an assignment time (S106). Subsequently, after starting a traffic amount measurement (S107), the path-specific count unit 11 returns to S101 and repeats subsequent processing.

Also, when a registration packet is not received in a state where the traffic measurement period is over (negative in S104), the path-specific count unit 11 finishes the traffic amount measurement (S108).

After that, the transmission time assignment unit 13 assigns a transmission time for packet transmission to each path, based on the traffic amount of each path calculated by the path-specific count unit 11 (S109).

Subsequently, the assignment information generation unit 14 generates an assignment report packet to report the transmission time assigned by the transmission time assignment unit 13 to each node (S110). Subsequently, after performing carrier sense and checking that a channel is available (S111), the packet transmission unit 16 transmits the assignment report packet generated by the assignment information generation unit 14 to each node (S112).

Also, in a case where a registration packet is received from a new node, it is possible to perform the processing in FIG. 7. Also, it may be periodically performed, performed at an arbitrary timing or performed in the case of detecting that a node is added or deleted.

Sequence

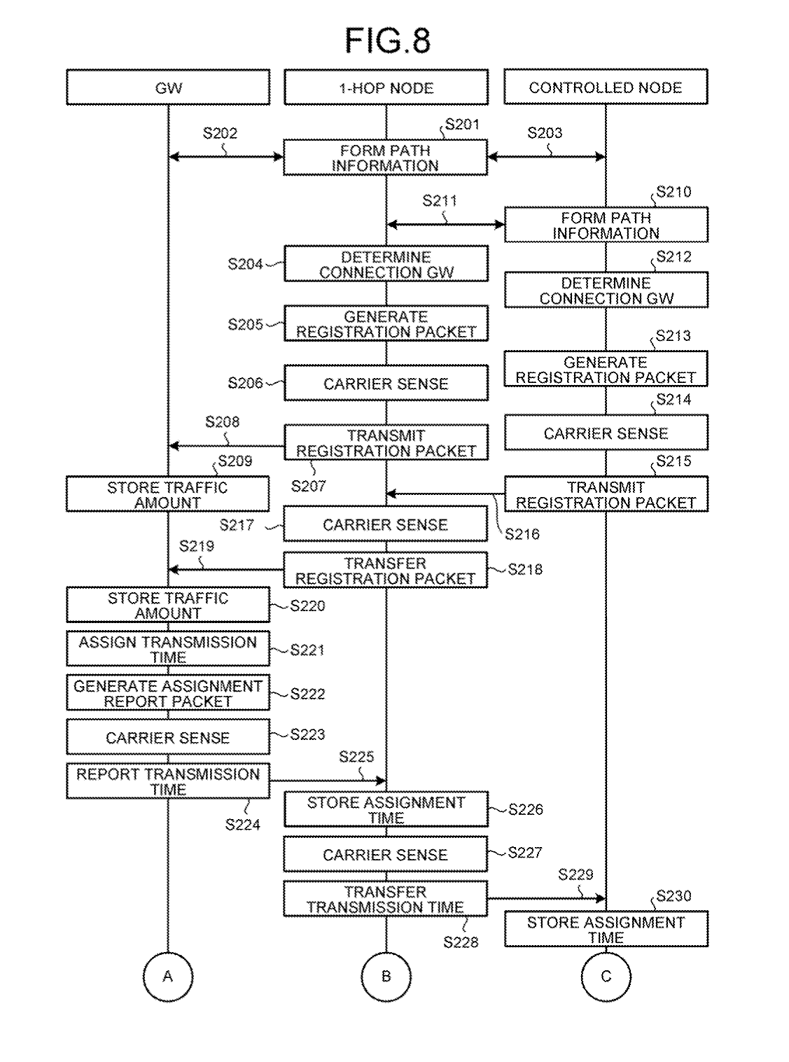

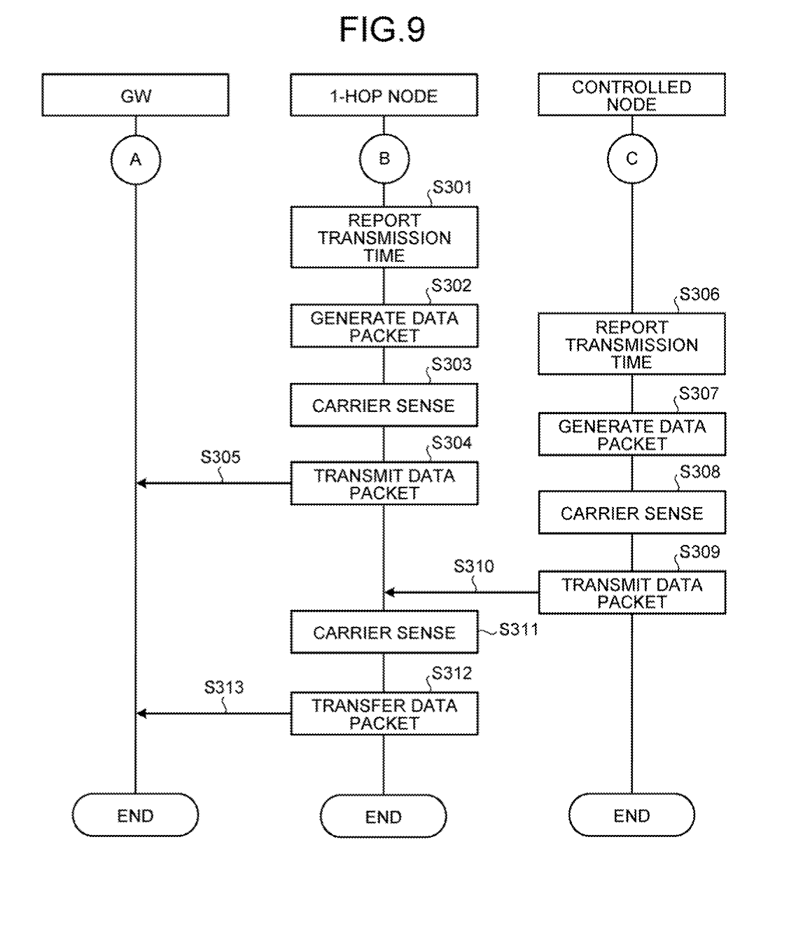

FIG. 8 and FIG. 9 are processing sequences performed in the wireless communication system according to the first embodiment. Also, in FIG. 8 and FIG. 9, although a 1-hop node and a controlled node that transmits data to the GW 10 via the 1-hop node are separately illustrated, the both nodes employ the configuration illustrated in FIG. 3 and therefore will be explained using the processing units and reference numerals explained in FIG. 3.

As illustrated in FIG. 8, the packet transmission unit 61 of the 1-hop node exchanges HELLO packets including path information with the GW 10, which can be communicated by one hop, and each controlled node, and forms path information (S201 to S203). Subsequently, the connection GW determination unit 53 determines the GW 10 of connection destination based on the formed path information or the like (S204). After that, the registration packet generation unit 54 generates a registration packet including the traffic amount to be transmitted by the local node (S205). Subsequently, after performing carrier sense and checking that a channel is available (S206), the packet transmission unit 61 transmits the registration packet to the GW 10 (S207 and S208).

The path-specific count unit 11 of the GW 10 calculates the traffic amount for each path going through the 1-hop node, based on the registration packet transmitted from the 1-hop node, and stores it in the path-specific traffic amount storage unit 12 (S209). That is, the path-specific count unit 11 extracts the “adjacent transmission source” and the “traffic amount to occur” from the registration packet, calculates the traffic amount sum every path going through the 1-hop node and stores the result in the path-specific traffic amount storage unit 12.

Also, the registration packet transmitted from the 1-hop node is received in not only the GW 10 but also the controlled node that can directly communicate with the 1-hop node. However, since the “final destination” or “adjacent destination” included in the registration packet does not store address information of the local node, the controlled node decides it as a packet not to be transferred and discards the received registration packet.

Also, the packet transmission unit 61 of the controlled node exchanges HELLO packets including path information with the 1-hop node, which can be communicated by one hop, and each controlled node, and forms path information (S210 and S211). Subsequently, the connection GW determination unit 53 of the controlled node determines the GW 10 of connection destination based on the formed path information or the like (S212). After that, the registration packet generation unit 54 of the controlled node generates a registration packet including the traffic amount to be transmitted by the local node (S213). Subsequently, after performing carrier sense and checking that a channel is available (S214), the packet transmission unit 61 of the controlled node transmits the generated registration packet to the GW 10 (S215 and S216).

After the packet type decision unit 51 of the 1-hop node decides the registration packet received from the controlled node as a transfer target and the packet transmission unit 61 performs carrier sense and checks that a channel is available (S217), S218 and S219 are performed. That is, after transfer processing is performed in the transfer processing unit 52, the packet transmission unit 61 transfers the registration packet to the destination GW 10.

At this time, the transfer processing unit 52 of the 1-hop node rewrites the “adjacent destination” by address information of an adjacent node and further rewrites the “adjacent transmission source” by address information of the local node. Also, the registration packet transmitted from the controlled node is received in not only the 1-hop node but also other controlled nodes that can directly communicate with the controlled node. However, as described above, since the “final destination” or “adjacent destination” included in the registration packet does not store address information of the local node, other controlled nodes decide it as a packet not to be transferred and discard the received registration packet.

The path-specific count unit 11 of the GW 10 calculates the traffic amount for each path going through the 1-hop node, based on the registration packet transmitted from the 1-hop node, and stores it in the path-specific traffic amount storage unit 12 (S220).

After that, the transmission time assignment unit 13 of the GW 10 assigns a transmission time for packet transmission to each path, based on the traffic amount of each path calculated by the path-specific count unit 11 (S221). Subsequently, the assignment information generation unit 14 generates an assignment report packet to report the transmission time assigned by the transmission time assignment unit 13 to each node (S222). After that, the packet transmission unit 16 performs carrier sense and checks that a channel is available (S223), and then performs broadcast transmission of the assignment report packet generated by the assignment information generation unit 14 (S224 and S225).

The assignment information reading unit 55 of the 1-hop node having received this assignment report packet extracts information directed to the local node, from the “representative terminal ID/assignment time of each area” of the received assignment report packet, and stores it in the assignment information storage unit 57 (S226). Also, the assignment information transfer processing unit 56 of the 1-hop node generates an assignment report packet, and, after performing carrier sense and checking that a channel is available (S227), the packet transmission unit 61 transmits the received assignment report packet to the controlled node (S228 and S229).

At this time, the assignment information transfer processing unit 56 of the 1-hop node may delete the “representative terminal ID/assignment time of each area” of other groups which are not related to the controlled node of the local node. Also, the “adjacent transmission source” is rewritten by address information of the local node. Here, similarly, although the assignment report packet transmitted from the 1-hop node is received in the GW 10 and other controlled nodes of the 1-hop node in addition to the controlled node that can directly communicate with the 1-hop node, if there is no information related to the GW 10 and other controlled nodes of the 1-hop node, it is discarded.

Also, the assignment information reading unit 55 of the controlled node extracts information directed to the local node, from the “representative terminal ID/assignment time of each area” of the assignment report packet received from the 1-hop node, and stores it in the assignment information storage unit 57 (S230). Here, the controlled node can recognize the “representative terminal ID/assignment time of each area” included in the received assignment report packet, as a transmission time assigned to the local node. Also, in a case where there are a plurality of items of “representative terminal ID/assignment time of each area” in the assignment report packet, the controlled node can recognize, as a transmission time, the “assignment time” associated with the “representative terminal ID of each area” corresponding to address information of the 1-hop node stored in advance. Also, the controlled node may include an address of an adjacent parent node instead of an address of the 1-hop node. In this case, the “representative terminal ID of each area” of the assignment report packet is an address of a transmission source terminal.

Subsequently, as illustrated in FIG. 9, the transmission timing determination unit 58 of the 1-hop node detects that it is the transmission time assigned to the local node (S301). Then, the packet generation unit 60 generates a data packet including a sensor value (S302). Subsequently, after performing carrier sense and checking that a channel is available (S303), the packet transmission unit 61 transmits the data packet to the GW 10 (S304 and S305). Also, although the data packet is received in others than the GW 10, it is discarded in the same reason as explained above.

Also, the transmission timing determination unit 58 of the controlled node detects that it is the transmission time assigned to the local node (S306). Then, the packet generation unit 60 generates a data packet including a sensor value (S307). Subsequently, after performing carrier sense and checking that a channel is available (S308), the packet transmission unit 61 transmits the data packet to the GW 10 (S309 and S310). Also, although the data packet is received in others than the 1-hop node, it is discarded in the same reason as explained above.

After that, the packet type decision unit 51 of the 1-hop node decides the data packet received from the controlled node as a transfer target, the packet transmission unit 61 performs carrier sense and checks that a channel is available (S311), and, subsequently, S312 and S313 are performed. That is, after transfer processing is performed in the transfer processing unit 52, the packet transmission unit 61 transfers the data packet to the destination GW 10.

### Specific Example

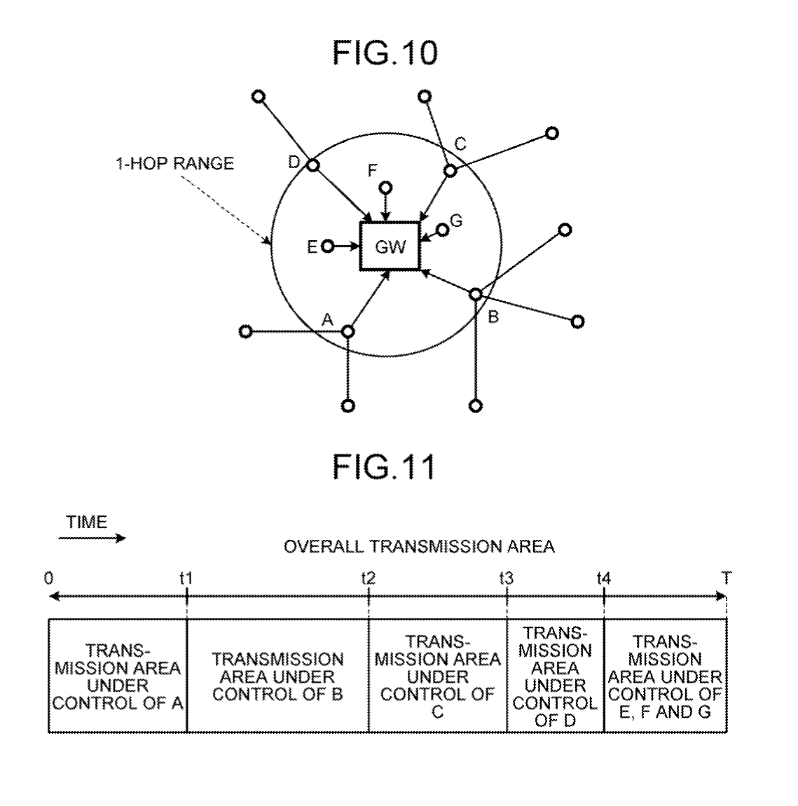

Next, a specific example of the above transmission time assignment will be explained using FIG. 10 and FIG. 11. Here, an example will be explained where a transmission time is assigned based on the number of nodes. FIG. 10 is a view illustrating a specific node arrangement example. FIG. 11 is a view illustrating a specific transmission time assignment example.

The wireless communication system illustrated in FIG. 10 includes a plurality of nodes and a GW. Among the plurality of nodes, nodes A, B, C, D, E, F and G are 1-hop nodes that can directly communicate with the GW. Also, as controlled nodes of the node A which transmit packets to the GW via the node A, two nodes are connected to the node A. Similarly, as controlled nodes of the node B which transmit packets to the GW via the node B, three nodes are connected to the node B. Similarly, as controlled nodes of the node C which transmit packets to the GW via the node C, two nodes are connected to the node C. Similarly, as a controlled node of the node D which transmits a packet to the GW via the node D, one node is connected to the node D. The nodes E, F and G do not have a controlled node.

In such a state, when each node is set in a predetermined position and activated, it exchanges an HELLO packet including path information with an adjacent node to form path information or determine a connection GW. For example, the node A exchanges HELLO packets with each node, which can directly communicate with the local node, and the GW.

Subsequently, after determining the connection destination GW, each node transmits a registration packet to the GW. For example, each 1-hop node directly transmits a registration packet to the GW. Also, the 1-hop node rewrites the “adjacent transmission source” of the registration packet received from a controlled node of the local node by “local node address information,” clarifies that it is a registration packet going through the local node, and then transfers it to the GW.

After that, the GW assigns a transmission time to each node based on the registration packet received from each node. For example, the GW finds that there are three registration packets going through the node A, four registration packets going through the node B, three registration packets going through the node C and two registration packets going through the node D. Also, the GW finds that there is one registration packet going through each of the nodes E, F and G.

As a result of this, the GW performs transmission time assignment such that the transmission time of the group of the node B is the longest, followed by the group of the node A, the group of the node C, the group of the node D, the group of the node E, the group of the node F and the group of the node G in order.

A result of such transmission time assignment is illustrated in FIG. 11. As illustrated in FIG. 11, the GW assigns a time period from 0 second after the start of transmission to t1 seconds, to the group of the node A as a transmission time, within a range of a whole transmission time T. Also, the GW assigns a time period from t1 seconds after the transmission start to t2 seconds, to the group of the node B as a transmission time. The GW assigns a time period from t2 seconds after the transmission start to t3 seconds, to the group of the node C as a transmission time. The GW assigns a time period from t3 seconds after the transmission start to t4 seconds, to the group of the node D as a transmission time. Further, the GW assigns the remaining time to the nodes E, F and G having no controlled node.

By this means, on the assumption that a more traffic amount transmitted to the GW is provided as the number of controlled nodes becomes more, it is possible to assign transmission time. For a node of more traffic, an area corresponding to the traffic amount is assigned. For a node of less traffic amount, an area reducing the whole transmission area by the assigned time is assigned. By this means, packets transmitted from nodes belonging to the nodes A, B, C and D can reach the GW without collision.

Also, packets transmitted from the nodes E, F and G having no controlled node can avoid collision with traffics transmitted from other nodes, and it is possible to prevent assignment information from being bloated due to excessive assignment area classification.

Also, it is possible to set from which group the transmission starts, in an arbitrary manner, for example, in order from the smaller device number. Also, in FIG. 10 and FIG. 11, a transmission time is assigned according to the number of controlled nodes and therefore the nodes E, F and G having no controlled node are processed as the same group. However, in the case of assigning a transmission time based on the number of bits to be transmitted, a transmission time may be assigned to each node instead of one group which is defined by grouping nodes having no controlled node.

Effect

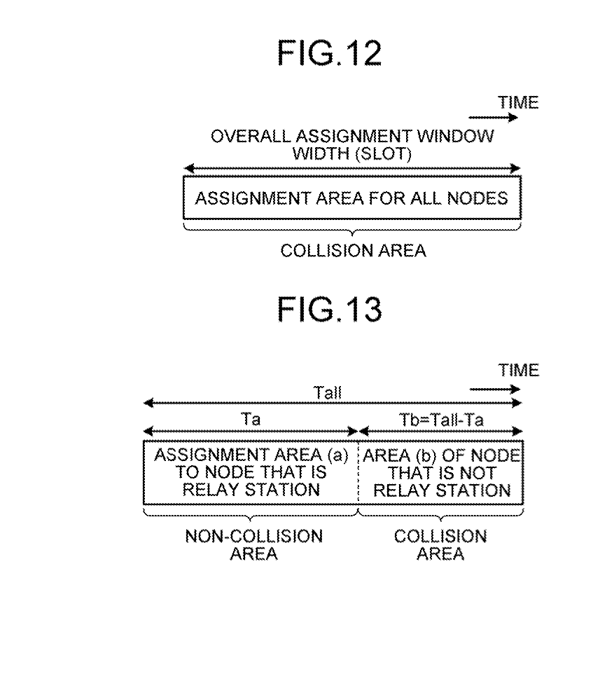

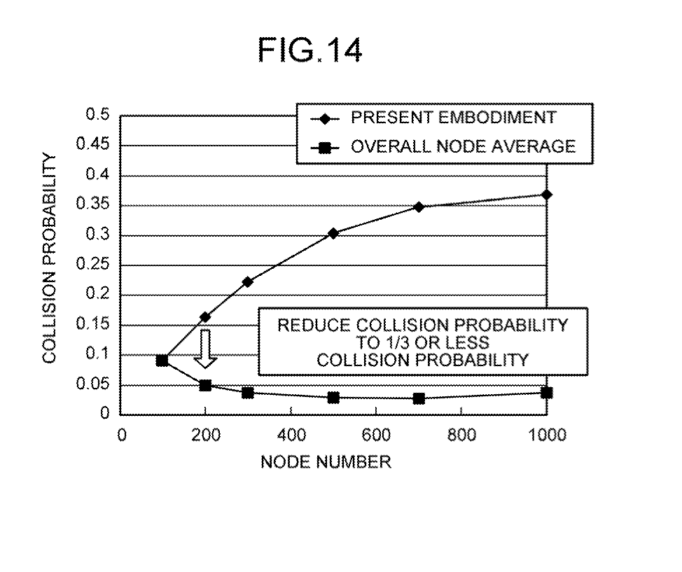

Next, advantages of the above embodiments will be explained using FIG. 12 to FIG. 14. FIG. 12 is a view for explaining an average collision rate in the case of using the related art. FIG. 13 is a view for explaining an average collision rate in the case of using the first embodiment. FIG. 14 is a view illustrating calculation results.

As illustrated in FIG. 12, in the case of the related art, all nodes simultaneously perform carrier sense in a range of the overall assignment window width (Tall) indicating a time period in which transmission is possible, and perform packet transmission. Therefore, the overall Tall is duration in which there is a possibility of collision in the time period in which transmission is possible.

Meanwhile, as illustrated in FIG. 13, in the case of adopting the first embodiment, in the overall assignment window width (Tall) indicating a time period in which transmission is possible, a time period assigned to each group is Ta and the remaining time period is Tb=Tall−Ta. This Ta is a time period in which packet transmission is performed by only a node of a group to which a transmission time is assigned, and is therefore a time period (non-collision area) in which it is possible to suppress packet collision. Also, Tb is a time period in which nodes having no controlled node perform packet transmission at the same time, and is therefore a time period (collision area) in which there is a possibility of packet collision.

That is, when FIG. 12 and FIG. 13 are compared, it is found that, in the case of using the first embodiment, compared to the related art, it is possible to reduce the possibility of packet collision by the time period of Ta. Here, a simulation result will be explained. Here, the number of nodes is increased while the node density is fixed. Also, the number of nodes having no controlled node, in other words, the number of nodes that are not a relay station is fixed regardless of an area increase. Also, the number of nodes having a controlled node, that is, the number of nodes that are a relay station increases as an area increases. In such conditions, a result of comparing an average packet collision rate to the total node number is illustrated in FIG. 14. Here, in FIG. 14, it is assumed that the overall assignment slot indicating the total transmission time is 2000, the total node number is (A)+(B), (A) is the number of nodes that are a relay station, and (B) is 100 (fixed value) indicating the number of nodes that are not a relay station.

As illustrated in FIG. 14, in the related art, the collision probability increases as the number of nodes increases. This is because, as illustrated in FIG. 12, the Tall is not changed even when the number of nodes increases, and therefore the probability of packet collision simply increases. By contrast with this, in the case of adopting the first embodiment, the collision probability decreases as the number of nodes increases, and therefore it is possible to suppress the probability to about one-third of that in the related art. This is because, as illustrated in FIG. 13, in a state where the Tall is a fixed value, the non-collision area Ta increases as the number of nodes increases.

As described above, according to the disclosed wireless communication system, it is possible to reduce the possibility of packet collision between nodes that transmit packets by the same hop number from a destination node. Also, according to the disclosed wireless communication system, the CSMA/CA scheme is merely employed in each node and the time division multiplexing scheme is not employed, and therefore it is possible to suppress the cost for node generation. As a result of this, it is possible to suppress packet collision at low cost.

### [b] Second Embodiment

Although an embodiment of the present invention has described above, the present invention can be implemented in various formats in addition to the above embodiment. Therefore, a different embodiment will be explained below.

Destination Node

Although an example has been described in the above embodiment where a destination node is a GW device, it is not limited to this, and it is possible to use an arbitrary node as destination.

Relay Method of Registration Packet

Although an example has been described in the above embodiment where each node transmits a registration packet to a GW and a 1-hop node transfers registration packets received from controlled nodes to the GW, it is not limited to this. For example, the 1-hop node may temporarily hold the registration packets received from the controlled nodes and collectively transmit these as one registration packet to the GW.

As a specific example, the node A illustrated in FIG. 1 temporarily holds registration packets received from the nodes B, C and D. After that, the registration packet generation unit 54 of the node A transmits one registration packet including four registration packets containing that of the local node to the GW. At this time, the registration packet generation unit 54 of the node A transmits, to the GW, the registration packets including a report that the number of nodes is 4, the traffic amount to occur in each node or the sum value of traffic amounts to occur in the nodes. By this means, it is possible to reduce the consumption of wireless resources related to registration packet transmission.

Relay Method of Assignment Report Packet

Also, in a 1-hop node, even in the case of transferring an assignment report packet received from a GW to a controlled node, it is possible to reduce the packet capacity. For example, the GW transmits, to each 1-hop node, an assignment report packet including the transmission time assigned to each 1-hop node, that is, the assignment time of each group. Subsequently, the transfer processing unit 52 of the 1-hop node deletes transmission time different from that of a group of the local node, from the assignment report packet, and the packet transmission unit 61 may transmit, to a controlled node, the assignment report packet in which the transmission time different from that of the group of the local node is deleted. Here, the packet transmission unit 61 may transmit the assignment report packet as is to the controlled node. Also, the 1-hop node can detect the transmission time assigned to the group of the local node, depending on whether it is associated with address information of the local node. By this means, it is possible to reduce the consumption of wireless resources related to assignment report packet transmission.

Recalculation

Although an example has been described in the above embodiment where, in the case of receiving a new registration packet from a new node, a GW recalculates transmission time assignment, it is not limited to this. For example, it may be periodically performed, performed in the case of detecting an increase or decrease of node, performed in a case where a path change occurs, or arbitrarily set. As a specific example, a GW detects an increase or decrease of node in a case where the number of registration packets received from a 1-hop node is different from the previous one. Also, the GW forms a path based on HELLO packets to be periodically transmitted and received, and, in a case where the currently formed path information is different from the previous one, detects that a path change occurs.

Packet Transmission in Transmission Time

For example, the packet transmission unit of each node can control packets transmitted within a transmission time assigned from a GW, by their types. As an example, regarding a data packet generated by the local node, the packet transmission unit of each node can control it to be transmitted within a transmission time assigned from the GW. That is, even if it is not the transmission time assigned from the GW, each node can transfer packets received from other nodes or transmit a registration packet generated in the local node. Also, regarding the registration packet and data packet generated in the local node, each node can control them to be transmitted within the transmission time assigned from the GW.

System

Also, in each processing explained in the present embodiment, it is possible to manually perform all or part of the processing explained as one automatically performed. Alternatively, by a well-known method, it is possible to automatically perform all or part of the processing explained as one manually performed. In addition to this, regarding information including the processing procedure, control procedure, specific names and various kinds of data or parameters illustrated in the above description and drawings, it can be arbitrarily changed if not otherwise specified.

Also, each illustrated component of each device is a functional concept and is not always requested to be physically configured as illustrated in the drawings. That is, the specific format of distribution/integration in each device is not limited to what is illustrated in the drawings. That is, depending on various loads or a use status, it is possible to form them by functionally or physically distributing or integrating all or part of them in an arbitrary unit. For example, it is possible to integrate the packet generation unit 60 and the packet transmission unit 61. Further, arbitrary part or all of each processing function performed in each device can be realized by a CPU and a program analyzed and executed by the CPU, or can be realized as hardware by wired logic.

According to an aspect of a wireless communication system, wireless communication control method and wireless communication device disclosed in the present application, there is an advantage that it is possible to suppress packet collision.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication system in which a plurality of nodes form a multi-hop wireless network, wherein
each node comprises:
a first transmission unit that transmits to a destination node a registration packet indicating that a local node is a node to request packet transmission; and
a second transmission unit that transmits a packet to the destination node within a transmission time reported from the destination node, and
the destination node comprises:
a calculation unit that receives a registration packet from the each node, and calculates a traffic amount to occur in each path for every path going through an adjacent node that enables direct communication with the destination node;
an assignment unit that assigns a transmission time to transmit the packet to the each path, based on the traffic amount of the each path calculated by the calculation unit; and
a report unit that reports the transmission time assigned by the assignment unit to the each node.

2. The wireless communication system according to claim 1, wherein the assignment unit of the destination node assigns the transmission time such that much transmission time is set in the each path in which the number of the registration packets received from the adjacent node or the sum of amounts of data to be transmitted from the each node is larger than a predetermined value, within a range of a time period in which it is possible to transmit data to the destination node.

3. The wireless communication system according to claim 1, wherein the adjacent node in the each node further comprises a report unit that reports a transmission time assigned to the local node in the transmission time received from the destination node, to a controlled node that transmits a packet to the destination node via the local node.

4. The wireless communication system according to claim 1, wherein the first transmission unit of the adjacent node in the each node generates a packet integrating information included in a registration packet received from each controlled node that transmits a packet to the destination node via the local node, and transmits the generated packet to the destination node.

5. The wireless communication system according to claim 1, wherein
the first transmission unit of the each node transmits the registration packet to the destination node in a case where a path to the destination node is changed, and
in a case of receiving the registration packet from one of the plurality of nodes, the assignment unit of the destination node assigns a transmission time to transmit the packet to the each path, using a registration packet received within a predetermined period after receiving the registration packet.

6. A wireless communication control method in a wireless communication system in which a plurality of nodes form a multi-hop wireless network, wherein
each node performs:
transmitting to a destination node a registration packet indicating that a local node is a node to request packet transmission; and
transmitting a packet to the destination node within a transmission time reported from the destination node, and
the destination node performs:
receiving a registration packet from the each node, and calculating a traffic amount to occur in each path for every path going through an adjacent node that enables direct communication with the destination node;
assigning a transmission time to transmit the packet to the each path based on the calculated traffic amount of the each path; and
reporting the assigned transmission time to the each node.

7. A wireless communication device comprising:
a first transmission unit that transmits, to a destination node in a multi-hop wireless network, a registration packet indicating that a local node is a node to request packet transmission; and
a second transmission unit that transmits a packet to the destination node within a transmission time reported from the destination node.

8. A wireless communication device comprising:
a reception unit that receives, from each node that forms a multi-hop wireless network, a registration packet indicating that the each node is a node to request a packet transmission;
a calculation unit that calculates, a traffic amount to occur in each path for every path going through an adjacent node that enables direct communication with a local node, based on the registration packet received by the reception unit;
an assignment unit that assigns a transmission time to transmit the packet to the each path based on the traffic amount of the each path calculated by the calculation unit; and
a report unit that reports the transmission time assigned by the assignment unit to the each node.
